(19) United States
(12) Patent Application Publication
(10) Pub. No.: US 2015/0232006 A1
(43) Pub. Date: Aug. 20, 2015

(54) HEATING APPARATUS FOR AUTOMOBILE SEAT AND CONTROL METHOD THEREOF

(71) Applicants: Hyundai Motor Company, Seoul (KR); Kia Motors Corporation, Seoul (KR)

(72) Inventors: Sang Uk YU, Seoul (KR); Byeong Seon Son, Hwaseong-si (KR); Seong Mun Yun, Hwaseong-si (KR); Chan Ho Jeong, Gunpo-si (KR); Gil Ju Kim, Seoul (KR); Seon Chae Na, Yongin-si (KR); Tae Hyung Kim, Hwaseong-si (KR)

(73) Assignees: Hyundai Motor Company, Seoul (KR); Kia Motors Corporation, Seoul (KR)

(21) Appl. No.: 14/543,728

(22) Filed: Nov. 17, 2014

(30) Foreign Application Priority Data
Feb. 20, 2014 (KR) 10-2014-0019419

(51) Int. Cl. B60N 2/56

(52) U.S. Cl. CPC B60N 2/5685

(57) ABSTRACT

An automobile seat heating system and a method of controlling the same includes an automobile seat heating system that can supply a current only to a seat cushion heating wire until before a predetermined early-reaching temperature is reached so that a user can more quickly feel earlier heating and warm, and a method of controlling the system.

### CROSS-REFERENCE TO RELATED APPLICATION

The present application claims priority to Korean Patent Application No. 10-2014-0019419 filed on Feb. 20, 2014, the entire contents of which is incorporated herein for all purposes by this reference.

### BACKGROUND

1. Field of the Invention

The present invention relates to an automobile seat heating system and a method of controlling the same, and more particularly, to an automobile seat heating system which can reduce the time taken to heat a seat up to a temperature at which a user can feel warm after sitting, and a method of controlling the system.

2. Description of Related Art

In general, automobile seats include a seat cushion supporting the user's hip and thighs thereon, a seat back supporting the user's back, and a head rest supporting the user's head and neck in order to make the user feel comfortable.

Those automobile seats, which need to be installed within limited space and weight in a vehicle so that passengers feel more comfortable and safe, are parts that users' bodies come in direct contact with, so they are parts that make the users most directly feel cold and hot.

Particularly, in wintertime, passengers feel so cold due to cold seats when they sit, and the seats take a long time to warm up by body heat or warm air from an air-conditioning system.

Accordingly, heat seating systems are used to increase seat temperature and heating wire seats, which have a built-in heating wire as a heating unit of a seat heating system and directly heat a seat with the heat from the heating wire by supplying a current to the heating wire, have been popularized.

FIG. 1 is a circuit diagram showing a seat heating system according to the related art. As shown in FIG. 1, the seat heating system includes heating wires 11 and 12 that are disposed in a seat cushion 1 and a seat back 2, respectively, and a controller 10 that controls the operation of the heating wires 11 and 12 by making power be selectively applied in accordance with turning-on/off by a user.

The heating wire 11 of the seat cushion and the heating wire 12 of the seat back are connected in series, and when power is applied by the controller 10, the heating wires 11 and 12 simultaneously generate heat and simultaneously heat the seat cushion 1 and the seat back 2, increasing in temperature.

Further, with the seat heating system operated by a user turning on a switch, the temperatures of the seat cushion 1 and the seat back 2 are automatically controlled to be able to be maintained within a predetermined range by a bimetal switch etc.

Alternatively, the temperatures of the seat cushion 1 and the seat back 2 are controlled within a predetermined range by the controller 10 controlling the power applied to the heating wires 11 and 12 in accordance with a sensing value of a temperature sensor (not shown) and FIG. 2 is a flowchart illustrating a method of controlling the seat heating system.

As shown in the figure, when a user turns on a switch (not shown) to operate the seat heating system after sitting on a seat (S1), the controller 10 allows a current to be simultaneously supplied to the heating wire 11 of the seat cushion 1 and the heating wire 12 of the seat back 2 (S2).

Since the heating wire 11 of the seat cushion 1 and the heating wire 12 of the seat back 2 are connected in series, the current simultaneously flows through the heating wires 11 and 12 and the temperatures of the seat cushion 1 an the seat back 2 simultaneously increase, and then, when the temperature value sensed by a seat temperature sensor reaches an overheating-upper limit temperature, the controller 10 cuts the currents supplied to the heating wires 11 and 12 (S3, S4, and S5).

Then, when the temperature value sensed by the temperature sensor reaches a heating-lower limit temperature, a current is supplied again to the heating wires 11 and 12 and the temperatures of the seat cushion 1 and the seat back 2 simultaneously increase (S6, S7, and S2).

Since a current is simultaneously applied or cut to the heating wires 11 and 12 in accordance with the temperature values sensed by the temperature sensor, as described above, the temperatures of the heating wires are controlled to be maintained between the overheating-upper limit temperature and the heating-lower limit temperature.

FIG. 3 is a diagram showing that the temperatures of a seat cushion and a seat back are simultaneously increased and controlled by a seat heating system according to the related art.

On the other hand, seat heating systems increase the temperature of a seat before the interior temperature of a vehicle reaches a predetermined level by an air-conditioning system in wintertime, such that they provide the advantage of making a user feel less cold.

However, a voltage is distributed to two heating wires that simultaneously operate in accordance with the resistance ratios of the heating wires and the amounts of heat by the heating wires depend on the distributed voltages, such that the heating wires slowly increase in temperature due to the amounts of heat by the heating wires which depend on the distributed voltages.

Therefore, there is a defect that it takes a little time to increase the temperature of the seat up to a level at which a user can feel warm.

That is, since the amounts of heat by heating wires are different due to distributed voltages in the systems in which a seat cushion heating wire and a seat back heating wire are connected in series and simultaneously receive power (two heating wires are simultaneously operated and the temperatures of a seat cushion and a seat back are simultaneously increased), it is difficult to increase the seat temperature within a short time with the heating wires.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an automobile seat heating system that can reduce the time taken to heat a seat up to a temperature at which a user can feel warm after sitting on the seat, and a method controlling the system.

Further, the present invention provides a seat heating system that can efficiently use electric power of a vehicle in an earlier heating process of increasing seat temperature after operating and in a seat temperature control process thereafter, and a method of controlling the system.

In an aspect of the present invention, an automobile seat heating system may include a seat cushion heating wire that is disposed in a seat cushion, with both ends connected with a power supply circuit and a grounding terminal, respectively, a seat back heating wire that is disposed in a seat back, with both ends connected with a power supply circuit and a grounding terminal, respectively, a switching unit that switches to selectively connect any one of the seat cushion heating wire and the seat back heating wire to a grounding terminal, and a controller that controls a switching of the switching unit, wherein the controller controls an operation of the switching unit to ground the seat cushion heating wire through the ground terminal so that a current flows only to the seat cushion heating wire and the seat cushion heating wire independently generates heat, in earlier heating for increasing a temperature of a seat.

The automobile seat heating system may further include a temperature sensor that senses a temperature of the seat cushion, wherein the controller makes the seat cushion heating wire independently operate to generate heat, until a sensing value of the temperature sensor reaches a predetermined earlier-reaching temperature.

When the sensing value of the temperature sensor reaches the earlier-reaching temperature, the controller controls the switching of the switching unit such that the seat cushion heating wire and the seat back heating wire alternately independently operate for a predetermined time, in order to increase the temperature of the seat back and control the temperatures of the seat back cushion and the seat back.

In another aspect of the present invention, a method of controlling an automobile seat heating system that controls a seat cushion heating wire and a seat back heating wire independently to generate heat, may include independently controlling the seat cushion heating wire to generate heat by making a current flow only to the seat cushion heating wire in an earlier heating process for increasing a temperature of a seat.

In the automobile seat heating system, both ends of each of the seat cushion heating wire and the seat back heating wire are connected with a power supply circuit and a grounding terminal, respectively, a switching unit that switches to selectively connect any one of the seat cushion heating wire and the seat back heating wire to the grounding terminal is provided, and an operation of the switching unit is controlled to ground the seat cushion heating wire through the grounding terminal in earlier heating for increasing the temperature of the seat, such that a current flows only to the seat cushion heating wire and the seat cushion heating wire independently operates to generate heat.

The seat cushion heating wire is independently controlled to generate heat, until a sensing value of a temperature sensor that senses a temperature of a seat cushion reaches a predetermined earlier-reaching temperature.

When the sensing value of the temperature sensor reaches the earlier-reaching temperature, the switching of the switching unit is controlled such that the seat cushion heating wire and the seat back heating wire alternately independently operate for a predetermined time, in order to increase the temperature of the seat back and control the temperatures of the seat back cushion and the seat back.

Therefore, according to the heat seating system and the method of controlling the system of the present invention, a current is supplied only to a seat cushion heating wire until a predetermined earlier-reaching temperature is reached so that a user more quickly feel the earlier heating and warm, such that it is possible to more quickly increase the temperature of a seat cushion and reduce the time taken to reach a temperature at which the user can feel warm.

Further, according to the present invention, since 100% of current that can be supplied flows to any one of two heating wires, the amounts of heat of the heating wires are increased, as compared with when the heating wires are simultaneously operated. Therefore, it is possible to quickly increase the temperature of the heating wires and the corresponding seat parts and reduce the current level for operating the heating wires, and thus it is possible to efficiently use the power.

The methods and apparatuses of the present invention have other features and advantages which will be apparent from or are set forth in more detail in the accompanying drawings, which are incorporated herein, and the following Detailed Description, which together serve to explain certain principles of the present invention.

The above and other features of the invention are discussed infra.

### BRIEF DESCRIPTION OF THE DRAWINGS

FIG. 1 is a circuit diagram showing a seat heating system according to the related art.

FIG. 2 is a flowchart illustrating a method of controlling the seat heating system according to the related art.

FIG. 3 is a diagram showing that the temperatures of a seat cushion and a seat back are simultaneously increased and controlled by a seat heating system according to the related art.

FIG. 4 is a circuit diagram for controlling a seat cushion heating wire and a seat back heating wire in a seat heating system according to an exemplary embodiment of the present invention.

FIG. 5 is a diagram illustrating the operation in an earlier heating process and a seat temperature control process in the circuit configuration shown in FIG. 4.

FIG. 6 is a flowchart illustrating a method of controlling a seat heating system according to an exemplary embodiment of the present invention.

FIG. 7 is a diagram showing control of turning on/off heating wires in an earlier heating process and a seat temperature control process in the present invention.

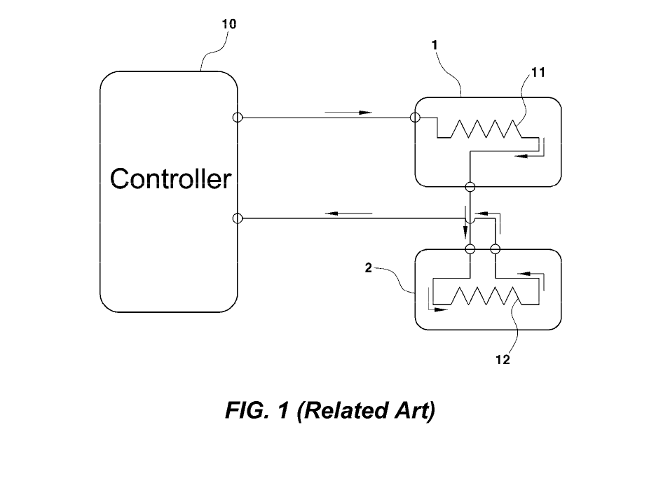

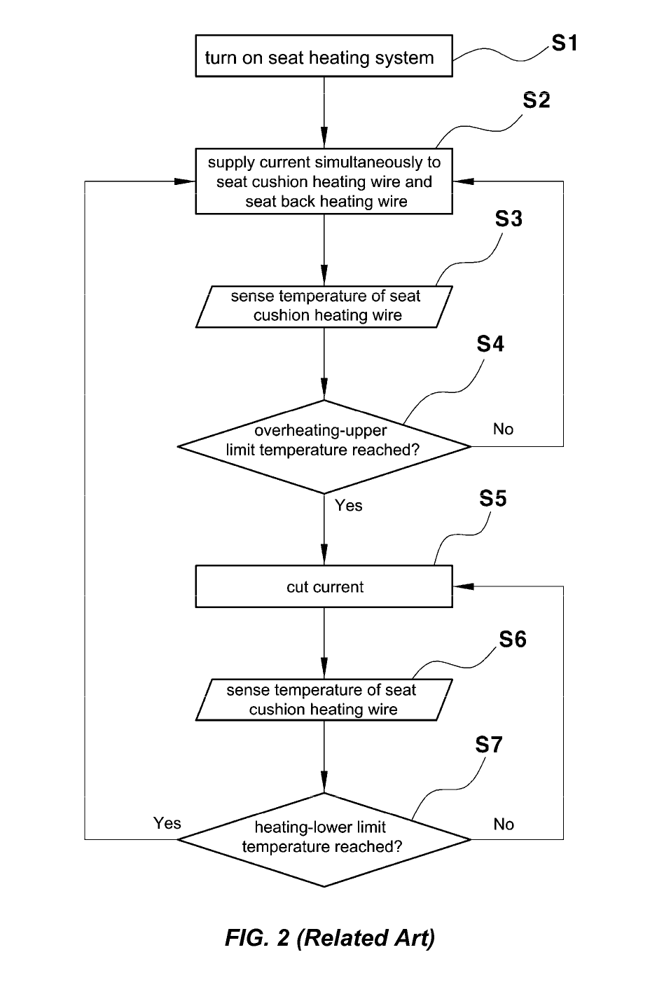

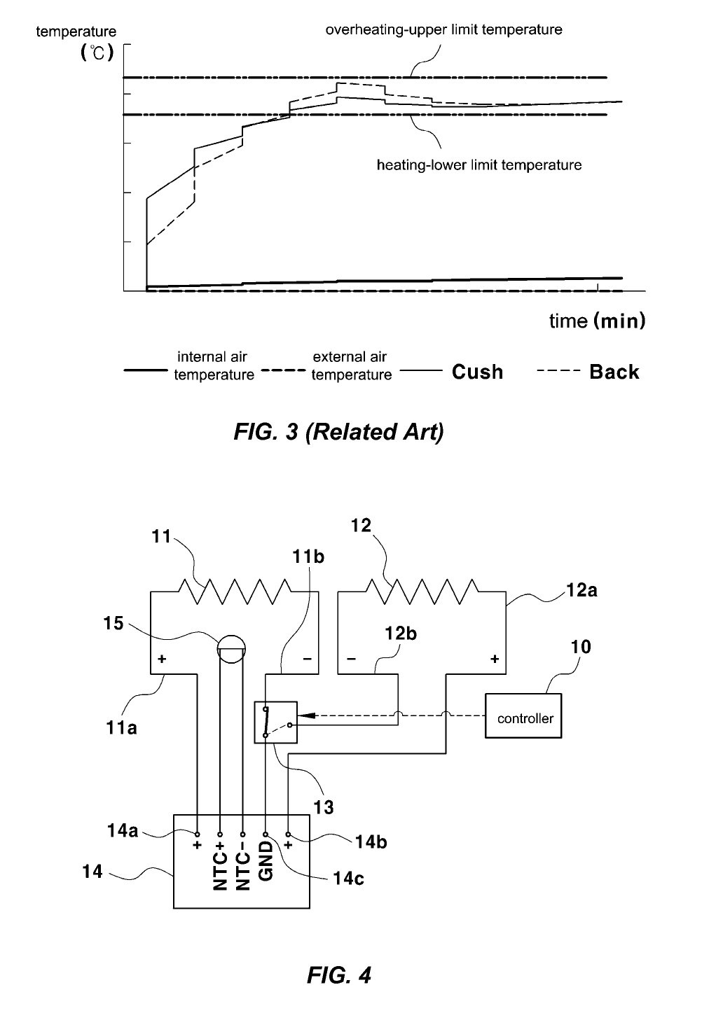

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described more fully with reference to the accompanying drawings for those skilled in the art to easily implement the present invention.

The present invention provides an automobile seat heating system that can reduce the time taken to heat a seat up to a temperature at which a user can feel warm after sitting on the seat, and a method controlling the system.

Further, another object of the present invention is to allow for efficient use of electric power of a vehicle in an earlier heating process of increasing seat temperature after operating and in a seat temperature control process thereafter, and a method of controlling the system.

To this end, the present invention provides a circuit configuration that can independently operate a seat cushion heating wire and a seat back heating wire in a seat heating system and a control method for reducing the time taken to increase seat temperature and efficiently using electric power in the circuit configuration.

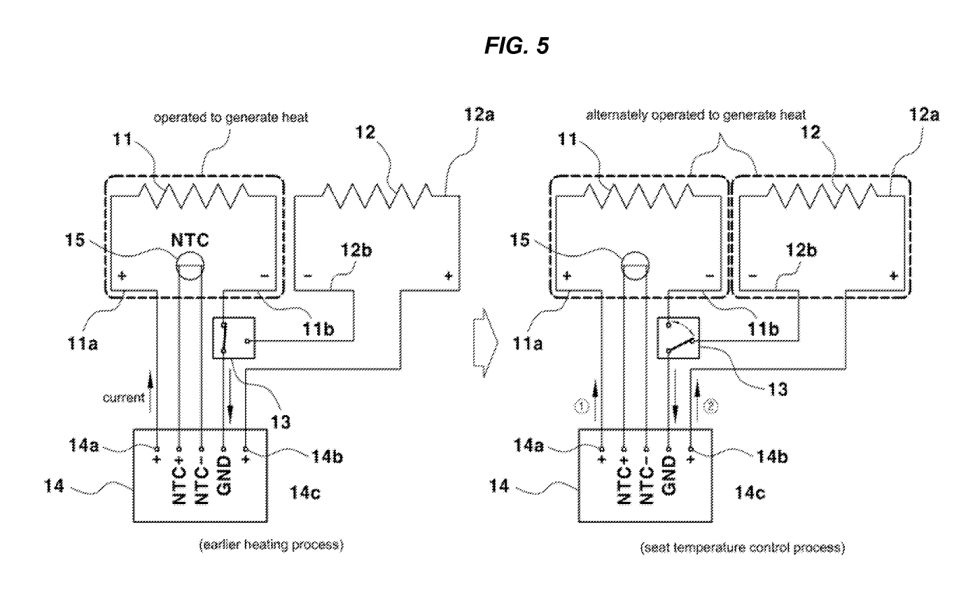

FIG. 4 is a circuit diagram for controlling the operation of a seat cushion heating wire 11 and a seat back heating wire 12 in a seat heating system according to an exemplary embodiment of the present invention and FIG. 5 is a diagram illustrating the operation in an earlier heating process (a) and a seat temperature control process (b) in the circuit configuration shown in FIG. 4.

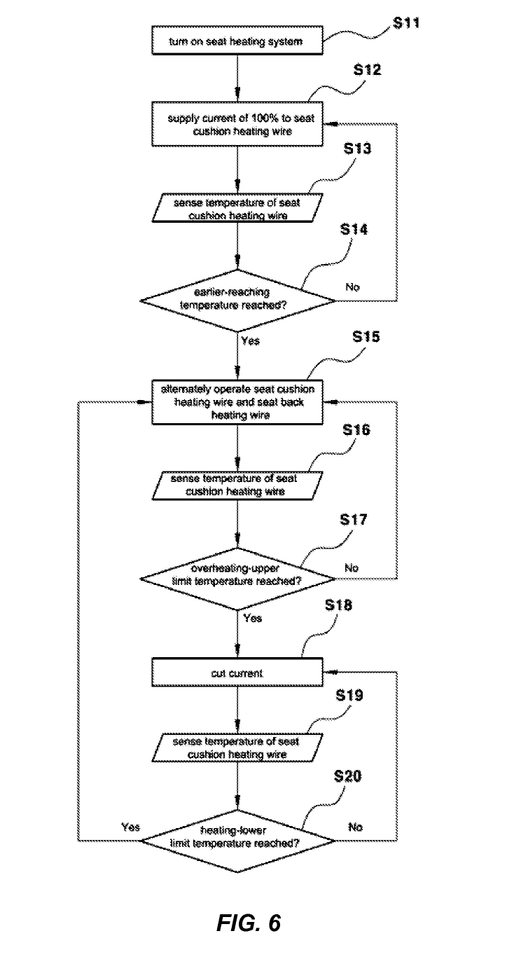

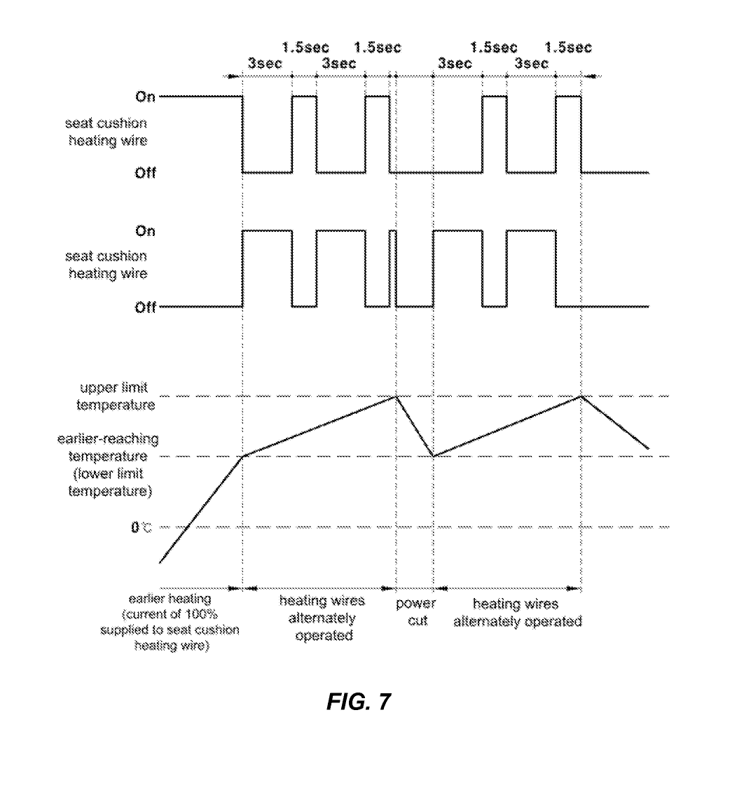

FIG. 6 is a flowchart illustrating a method of controlling a seat heating system according to an exemplary embodiment of the present invention and FIG. 7 is a diagram showing control of turning on/off heating wires in an earlier heating process and a seat temperature control process.

First, as shown in FIG. 4, a seat heating system of the present invention includes a circuit configuration that can independently supply power to a seat cushion heating wire 11 and a seat back heating wire 12, such that the seat cushion heating wire 11 and the seat back heating wire 12 can be independently operated by the circuit configuration.

In detail, the seat cushion heating wire 11 and the seat back heating wire 12 each have both ends connected to a power supply circuit and a grounding terminal through a power input line (+ line) and a grounding line (− line).

That is, the power input lines (+ lines) 11a and 12a of the seat cushion heating wire 11 and the seat back heating wire 12 are separated to be able to independently receive operation power (operation current) from a power unit of a vehicle, that is, a battery. Further, the power input lines 11a and 12a are separately connected to the power supply circuit and independently receive power.

For example, the power lines 11a and 12a are of the heating wires 11 and 12 are respectively connected to positive (+) terminals 14a an 14b of a connector 14 that connects the heating wires 11 and 12 to the outside and power supply circuits that supply operation power are separately connected to the positive (+) terminals 14a and 14b.

The grounding ends of the heating wires 11 and 12 may be used in common, the grounding lines (− lines) 11b and 12b for grounding of the heating wires 11 and 12 are connected to a common grounding terminal 14c through a switching unit 13, and accordingly, the seat cushion heating wire 11 can be grounded or the seat back heating wire 12 can be grounded in accordance with switching of the switching unit 13.

The switching of the switching unit 13 is controlled by a controller 10 and the contact point connection in the switching unit 13 is switched in response to control signals from the controller 10, such that the seat cushion heating wire 11 is grounded or the seat back heating wire 12 is grounded by the switching unit 13.

Therefore, with the heating wires 11 and 12 being able to receive power through the power input lines 11a and 12a (with the seat heating system turned on), when the switching unit 13 grounds the seat cushion heating wire 11, the power of 100% that can be supplied from the outside flows only through the seat cushion heating wire 11, so only the seat cushion heating wire 11 can independently operate to generate heat (only the seat cushion is heated).

Further, when the switching unit 13 grounds the seat back heating wire 12, the current of 100% that can be supplied from the outside flows only through the seat back heating wire 12, so only the seat back heating wire 12 can independently operate to generate heat.

Further, the seat heating system of the present invention further includes a temperature sensor 15 that senses the temperature of the seat cushion and the temperature sensor 15 may be a temperature sensor that senses the temperature of the seat cushion heating wire 11, for example, an ntc thermestor.

The operation and control process are described with reference to FIGS. 5 to 7. When a user turns on a switch to operate the seat heating system after sitting on a seat (S11), the controller 10 performs an earlier heating process for increasing the temperature of the seat up to a predetermined earlier-reaching temperature by operating the heating wire.

The controller 10 performs a seat temperature control process for controlling the operation of the heating wire so that the seat temperature can be maintained within a predetermined temperature range after the earlier heating.

As described above, in the seat heating system in which the earlier heating process and the seat temperature control process are performed, only the seat cushion is increased fast in temperature by the operation of the seat cushion heating wire 11 by making a current flow only through the seat cushion heating wire 11 in the earlier heating process in an exemplary embodiment of the present invention (S12) (see the section ‘earlier heating’ in FIG. 7).

Further, when the temperature of the seat cushion which is sensed by the temperature sensor 15 reaches the predetermined earlier-reaching temperature, the seat temperature control process, which increases the temperature of the seat back by alternately operating the seat cushion heating wire 11 and the seat back heating wire 12 for a predetermined time (independently operating them with an interval) (S13, S14, and S15) and then keeps the temperatures of the seat cushion and the seat back within a predetermined temperature range, is performed.

The controller 10 allows a current to alternately flow to the seat cushion heating wire 11 and the seat back heating wire 12 by controlling the switching of the switching unit 13, in which the contact point connection in the switching unit 13 is switched in response to control signals from the controller 10 so that a current alternately flows to the heating wires for a predetermined time, such that the heating wires alternately operate to generate heat (see the section ‘alternate operation of heating wires’ in FIG. 7).

Further, when the seat cushion and seat back temperatures (or the temperatures of the heating wires) reach a predetermined upper limit temperature in the seat temperature control process, a bimetal switch that cuts operation power for the heating wires may be used. In this case, when the temperatures reach the upper limit temperature, the bimetal switch is turned off to cut the operation power for the heating wires and prevent the heating wires from being overheated.

Alternatively, instead of the bimetal switch, it may be possible to use a control type that keep the seat cushion and seat back temperatures within a predetermined temperature range by turning on/off switching devices in the power input lines 11a and 12a of the heating wires 11 and 12 or in an external power supply circuit on the basis of the sensing value of the temperature sensor 15 (see FIG. 6).

That is, when the sensing value of the temperature sensor 15 reaches a predetermined overheating-upper limit temperature, in order to keep the temperature within a predetermined temperature range, the controller 10 outputs a control signal for cutting the power for the heating wires 11 and 12 and the switching devices are turned off, and thus the operation power supplied to the heating wires is cut (S16, S17, and S18) (see the section ‘power cut’ in FIG. 7).

Further, when the sensing value of the temperature sensor 15 decreases to a heating-lower limit temperature after the operation power is cut (S19 and S20), the controller 10 outputs a control signal for supplying power and the switching devices are turned on, such that operation power can be supplied to the heating wires 11 and 12.

However, in the seat temperature control process, even if operation power can be supplied to the heating wires 11 and 12, the operation current flows only through the heating wire grounded in accordance with the switching status of the switching unit 13 and only the heating wire through which the operation current flows operates to generate heat.

Obviously, as described above, in the seat temperature control process, alternate operation control in which the controller 10 alternately operates the heating wires 11 and 12 to generate heat for a predetermined time by alternately controlling the switching unit 13 is performed (S15).

FIG. 7 shows an example of alternately operating the seat cushion heating wire for 1.5 seconds and the seat back heating wire for 3 seconds in the seat temperature control process, but the operation times of the heating wires are only example and can be variously changed.

For reference, a drivers or passengers generally wear more upper clothes in comparison to the lower clothes and usually wear the lower clothes thinner than the upper clothes in wintertime.

Further, when a driver or a passenger sits on a seat, the hip and the thighs are necessarily in close contact with the seat cushion, but the back is not.

Further, actually, most drivers and passengers want that the cold feeling on the hip being in close contact with the seat cushion is quickly removed, before the interior air of a vehicle is warmed up by an air-conditioning system in wintertime.

Accordingly, when the seat cushion is heated first and then the seat back is heated with a user in the seat, the user can feel the earlier heating more quickly and feels warm more quickly.

In particular, when only the seat cushion heating wire is independently operated to generate heat in the earlier heating process, that is, when 100% of the current that the seat heating system can receive is made flow only to the seat cushion heating wire, the amount of heat generated by the seat cushion heating wire is increased, as compared with when the two heating wires are simultaneously operated, and accordingly, the temperatures of the seat cushion and the heating wire can be more quickly increased. Accordingly, it is possible to reduce the time taken to reach a temperature at which the user can feel warm.

In consideration of this matter, in the seat heating system of the present invention, a control of making 100% of current flow to the seat cushion heating wire is performed in the earlier heating process, as described above, control of alternately operating the seat cushion heating wire and the seat back heating wire is performed in the seat temperature control process after the earlier heating process.

A current alternately flows to the seat cushion heating wire and the seat back heating wire in the seat temperature control process, in which, similarly, 100% of current that can be supplied flows to any one of the heating wires, such that the amounts of heat of the heating wires increase, as compared with when the heating wires are simultaneously operated. Accordingly, it is possible to quickly increase the temperatures of the heating wires and the corresponding seat parts and to decrease the current level for operating the heating wires, and thus it is possible to efficiently use the electric power.

Therefore, according to the heat seating system and the method of controlling the system of the present invention, a current is supplied only to a seat cushion heating wire until before a predetermined earlier-reaching temperature is reached so that a user more quickly feel the earlier heating and warm, such that it is possible to more quickly increase the temperature of a seat cushion and reduce the time taken to reach a temperature at which the user can feel warm.

Although embodiments of the present invention were described in detail above, the scope of the present invention is not limited to the embodiments and various changes and modifications from the spirit of the present invention defined in the following claims by those skilled in the art are also included in the scope of the present invention.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automobile seat heating system comprising:
a seat cushion heating wire that is disposed in a seat cushion, with both ends connected with a power supply circuit and a grounding terminal, respectively;
a seat back heating wire that is disposed in a seat back, with both ends connected with a power supply circuit and a grounding terminal, respectively;
a switching unit that switches to selectively connect any one of the seat cushion heating wire and the seat back heating wire to a grounding terminal; and
a controller that controls a switching of the switching unit,
wherein the controller controls an operation of the switching unit to ground the seat cushion heating wire through the ground terminal so that a current flows only to the seat cushion heating wire and the seat cushion heating wire independently generates heat, in earlier heating for increasing a temperature of a seat.

2. The automobile seat heating system of claim 1, further comprising:
a temperature sensor that senses a temperature of the seat cushion,
wherein the controller makes the seat cushion heating wire independently operate to generate heat, until a sensing value of the temperature sensor reaches a predetermined earlier-reaching temperature.

3. The automobile seat heating system of claim 2, wherein when the sensing value of the temperature sensor reaches the earlier-reaching temperature, the controller controls the switching of the switching unit such that the seat cushion heating wire and the seat back heating wire alternately independently operate for a predetermined time, in order to increase the temperature of the seat back and control the temperatures of the seat back cushion and the seat back.

4. A method of controlling an automobile seat heating system that controls a seat cushion heating wire and a seat back heating wire independently to generate heat, comprising:
independently controlling the seat cushion heating wire to generate heat by making a current flow only to the seat cushion heating wire in an earlier heating process for increasing a temperature of a seat.

5. The method of claim 4, wherein in the automobile seat heating system, both ends of each of the seat cushion heating wire and the seat back heating wire are connected with a power supply circuit and a grounding terminal, respectively, a switching unit that switches to selectively connect any one of the seat cushion heating wire and the seat back heating wire to the grounding terminal is provided, and an operation of the switching unit is controlled to ground the seat cushion heating wire through the grounding terminal in earlier heating for increasing the temperature of the seat, such that a current flows only to the seat cushion heating wire and the seat cushion heating wire independently operates to generate heat.

6. The method of claim 4, wherein the seat cushion heating wire is independently controlled to generate heat, until a sensing value of a temperature sensor that senses a temperature of a seat cushion reaches a predetermined earlier-reaching temperature.

7. The method of claim 6, wherein when the sensing value of the temperature sensor reaches the earlier-reaching temperature, the switching of the switching unit is controlled such that the seat cushion heating wire and the seat back heating wire alternately independently operate for a predetermined time, in order to increase the temperature of the seat back and control the temperatures of the seat back cushion and the seat back.
